(19) United States
(12) Patent Application Publication
(10) Pub. No.: US 2025/0310921 A1
(43) Pub. Date: Oct. 2, 2025

(54) SYSTEM AND METHOD FOR DETERMINING PRECISE LOCATION OF A UE IN A NETWORK

(71) Applicant: JIO PLATFORMS LIMITED, Ahmedabad (IN)

(72) Inventors: Yatin GUJAR, Mumbai (IN); Shilpa SALUNKHE, Mumbai (IN); Thiagarajan ARUMUGAM, Mumbai (IN)

(73) Assignee: JIO PLATFORMS LIMITED, Ahmedabad (IN)

(21) Appl. No.: 18/728,267

(22) PCT Filed: Jan. 13, 2023
(86) PCT No.: PCT/IB2023/050303

§ 371 Date: Jul. 11, 2024

(30) Foreign Application Priority Data
Jan. 13, 2022 (IN) 202221001933

(51) Int. Cl. H04W 64/00; G01S 19/25; H04W 4/029

(52) U.S. Cl. CPC H04W 64/00; G01S 19/252; H04W 4/029

(57) ABSTRACT

The present invention provides an efficient and reliable systems and methods for facilitating a fixed coarse reference coordinate populated in locations platform. The granularity of this coarse location reference can be at a combination of Mobile Country Code (MCC) and Mobile Network Code (MNC) level. Whenever there is serving cell ID received which is not populated in locations platform cell ID database (DB), the locations platform can consider a default reference coordinate basis that can be a combination of MCC and MNC value received in an E-UTRAN Cell Global Identifier (ECGI) format of the serving cell ID information. This ensures that always coarse reference coordinates are available with locations platform which can be considered to identify which satellites are best visible to a given UE and accordingly send the assistance data for computing the location basis AGNSS method.

### FIELD OF INVENTION

The embodiments of the present disclosure generally relate to telecommunication deployment. More particularly, the present disclosure relates to systems and methods for facilitating assisted Global Navigation Satellite System (AGNSS) based location query for computing the precise location of a user equipment (UE).

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

With the advent of mobility technology, there has always been a need to accurately locate a given mobility device. The device location is largely required for business driven location based services like:
Navigation.
Search and advertising—Special deals or offers from retailers in given area
Tracking—Personal tracker, courier services, find a friend, etc.
Games and augmented reality

In addition to these business applications, the second biggest need for location services is for emergency service and Law enforcement requirements. Today there are many over the top (OTT) applications which provide such services but these are largely dependent on data connectivity, user permissions and driven by 3rd party application design. To get location, independent of above limitations along with authenticity, network based location is considered to be most reliable form of location data source. 3GPP has defined standards for location services pertaining to GSM as well as for 4G and 5G services.

Below are the Network based locations methods which are widely used for 4G and 5G services.
4G Network based Location methods:
   A-GNSS
   Observed Time Difference of Arrival (OTDOA)
   Uplink enhanced cell identity (UL E-CID)
   Downlink (DL) E-CID
   Wireless local area network (WLAN)
   Bluetooth
   Transport Block Size (TBS)
   DL-Time Difference of Arrival (TDOA)
   DL-Always on Display (AoD)
   Multi-round trip time (RTT)
   New radio (NR) E-CID
   UL-TDOA
   UL-AoA

In today's world, location based services are of prime importance for entities as well as from providing emergency assistance for person in need. With case and in depth penetration of mobility technology, providing location based services has been quite effective. To support above requirements, various methods have been introduced for deriving the location of a user equipment (UE) over data as well as control plane. With advanced technologies like 4G and 5G as well as with smarter mobile devices, it has been possible to locate a UE as precise as up to 5 mtrs. An assisted global navigation satellite system (AGNSS) based location query is considered to be one of the most accurate location methods available in 4G network. For AGNSS to work successfully, the device should have support for AGNSS along with support for 3GPP defined LTE positioning protocol (LPP) protocol stack.

For this method to be successful, AGNSS based location support is required in the UE along with LPP protocol support. Additionally, the serving 4G or 5G network should have 3GPP defined location services platform capable of executing AGNSS based location query. Here, there are two options by which the location can be computed viz:
UE based—Here the location coordinates are computed by the UE using assistance data provided by the locations platform
UE assisted—Here the UE provides the satellite reference signal data as received from GPS satellites visible to the UE. The location coordinates are computed basis the algorithm deployed in locations platform

Providing accurate location information is of prime importance for the success of location-based services. Due to technical limitations at UE end or at network end, the success ratio of location method varies. In order to send the assistance data to UE, the locations platform need to know the coarse location of the UE. This is primarily derived from the serving cell ID information which locations platform receives at the start of AGNSS based location query. The prerequisite for this call flow is, the locations platform should have complete network Cell ID vis deployed location coordinate database populated. If for any reason, a given cell ID information is missing, then the AGNSS based location computation fails due to lack of coarse reference location information with locations platform.

Therefore, there is a need in the art to provide systems and methods that can overcome the shortcomings of the existing prior art.

### OBJECTS OF THE PRESENT DISCLOSURE

Some of the objects of the present disclosure, which at least one embodiment herein satisfies are as listed herein below.

An object of the present disclosure is to provide for a system that addresses dependency of AGNSS based location query success on Service Cell ID location information.

An object of the present disclosure is to provide for a system that improves AGNSS based location query method success rate.

An object of the present disclosure is to provide for a system that enhances possibility of high accurate location output from location services platform.

An object of the present disclosure is to provide for a system that improves response time of location query by minimizing the need to fallback from AGNSS based location to other less accurate location methods.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a system for predicting precise location of a user equipment (UE) in a communication network. The system may include one or more processors operatively coupled to one or more UE that may be associated with one of more users. The one or UE may be communicatively coupled to one or network elements (cells) of the communication network. Further, the one or more processors may execute a set of executable instructions that are stored in a memory, upon execution of which, the one or more processors may cause the system to receive a first set of data packets pertaining to queries associated with location of a UE and further receive a second set of data packets, pertaining to a page request initiation response to the queries associated with the location of the UE. The system may be further configured to extract, from the UE, a first set of attributes based on the second set of data packets, the first set of attributes pertaining to a serving cell ID of the UE and also extract, a second set of attributes, based on the second set of data packets, the second set of attributes pertaining to a static coarse location data of the UE. The static coarse location may include mobile country codes (MCC) and mobile network codes (MNC) and corresponding location coordinates associated with the location of the UE. Based on the extracted first and second set of attributes, the system may be configured to collect, a satellite reference data associated with a probable area in which the UE is available, identify from the satellite reference data, best visible satellites serving the probable area in which the UE is available and, further derive the exact latitude and longitude coordinates associated with the location of the UE from the identified best visible satellite co-ordinates.

In an embodiment, the system may be further configured to extract a third set of attributes from the received the first set of attributes, the third set of attributes pertaining to requested QoS and serving cell identity (ID) in an E-UTRAN Cell Global Identifier (ECGI) format.

In an embodiment, the system may be further configured to receive the third set of attributes from the UE.

In an embodiment, the system may be further configured to send the location request to an Emergency Serving Mobile Location Centre (ESMLC) that may include a requested Quality of Service (QOS) and the serving cell id in the ECGI format as received from the UE.

In an embodiment, the satellite reference data may be obtained by the UE after sending a request for the satellite reference data to a predefined data base comprising the satellite reference data of a plurality of UEs serving the probable area.

In an embodiment, the system may be further configured to consider the satellite reference data corresponding to the UE that provides a predetermined GNSS satellite signal for computing location.

In an embodiment, the system may be further configured to store the static coarse location in the coarse reference database which contains ECGI value, latitude and longitude values of the UE.

In an embodiment, the system may be further configured to create the coarse reference database as a fallback which is used whenever there is a missing serving cell ID location information.

In an embodiment, the system may be further configured to maintain the coarse reference database at par with ever increasing footprint for mobility networks.

In an embodiment, the system may be further configured to determine respective location coordinates of the UE based on the serving MCC and MNC values, wherein the location coordinates is the latitude and longitude values of approximate centroid of the said MCC and MNC geography.

In an aspect, the present disclosure provides for a user equipment (UE) for predicting precise location of a second user equipment (UE) in a communication network. The UE may include a processor operatively coupled to one or more second UE. The one or second UE may be communicatively coupled to one or network elements (cells) of the communication network. The processor may further execute a set of executable instructions that are stored in a memory, upon execution of which, the processor may cause the UE to receive a first set of data packets pertaining to queries associated with location of a UE and further receive a second set of data packets, pertaining to a page request initiation response to the queries associated with the location of the UE. The UE may be further configured to extract, from the UE, a first set of attributes based on the second set of data packets, the first set of attributes pertaining to a serving cell ID of the UE and also extract, a second set of attributes, based on the second set of data packets, the second set of attributes pertaining to a static coarse location data of the UE. The static coarse location may include mobile country codes (MCC) and mobile network codes (MNC) and corresponding location coordinates associated with the location of the UE. Based on the extracted first and second set of attributes, the UE may be configured to collect, a satellite reference data associated with a probable area in which the UE is available, identify from the satellite reference data, best visible satellites serving the probable area in which the UE is available and, further derive the exact latitude and longitude coordinates associated with the location of the UE from the identified best visible satellite co-ordinates.

In an aspect, the present disclosure provides for a method for predicting precise location of a user equipment (UE) in a communication network. The method may include the step of receiving, by one or more processors a first set of data packets pertaining to queries associated with location of a UE. In an embodiment, the one or more processors may be operatively coupled to one or more UE associated with one or more users, the one of UE may be communicatively coupled to one or network elements (cells) of the communication network. The one or more processors may further execute a set of executable instructions that are stored in a memory. The method may also include the step of receiving, by the one or more processors, a second set of data packets pertaining to a page request initiation response to the queries associated with the location of the UE and the step of extracting, by the one or more processors, from the UE, a first set of attributes based on the second set of data packets, the first set of attributes pertaining to a serving cell ID of the UE. Further the method may include the step of extracting, by the one or more processors, a second set of attributes, based on the second set of data packets, the second set of attributes pertaining to a static coarse location data of the UE, and wherein the static coarse location contains mobile country codes (MCC) and mobile network codes (MNC) and corresponding location coordinates associated with the location of the UE. Based on the extracted first and second set of attributes, the method may include the step of collecting, by the one or more processors, a satellite reference data associated with a probable area in which the UE is available. The method may then include the step of identifying, by the one or more processors, from the satellite reference data, best visible satellites serving the probable area in which the UE is available. Furthermore, the method may include the step of deriving, by the one or more processors, the exact latitude and longitude coordinates associated with the location of the UE from the identified best visible satellite co-ordinates.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates an exemplary system architecture in which or with which proposed system of the present disclosure can be implemented, in accordance with an embodiment of the present disclosure.

FIG. 1B illustrates an exemplary block diagram representation of proposed system for predicting precise location of a user equipment (UE) of a telecommunication network, in accordance with an embodiment of the present disclosure.

FIG. 1C illustrates an exemplary block diagram representation of proposed UE for predicting precise location of a user equipment (UE) of a telecommunication network, in accordance with an embodiment of the present disclosure.

FIG. 2 illustrates an exemplary representation of a 3GPP defined AGNSS Location query call flow, in accordance with an embodiment of the present disclosure.

FIG. 3 illustrates an exemplary representation of AGNSS Location query call flow with the proposed system, in accordance with an embodiment of the present disclosure.

FIG. 4 illustrates an exemplary flow diagram of a method with which embodiments of the present invention may be implemented, in accordance with embodiments of the present disclosure.

FIG. 5 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present invention provides an efficient and reliable systems and methods for facilitating a fixed coarse reference coordinate populated in locations platform. The granularity of this course location reference can be at a combination of Mobile Country Code (MCC) and Mobile Network Code (MNC) level. Whenever there is serving cell ID received which is not populated in locations platform cell ID database (DB), the locations platform can consider a default reference coordinate basis that can be a combination of MCC and MNC value received in an E-UTRAN Cell Global Identifier (ECGI) format of the serving cell ID information. This ensures that always coarse reference coordinates are available with locations platform which can be considered to identify which satellites are best visible to a given UE and accordingly send the assistance data for computing the location basis AGNSS method.

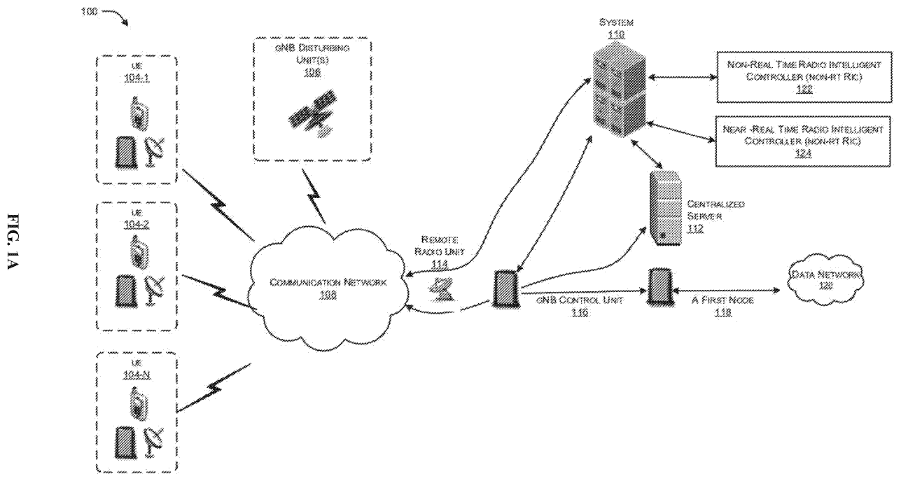

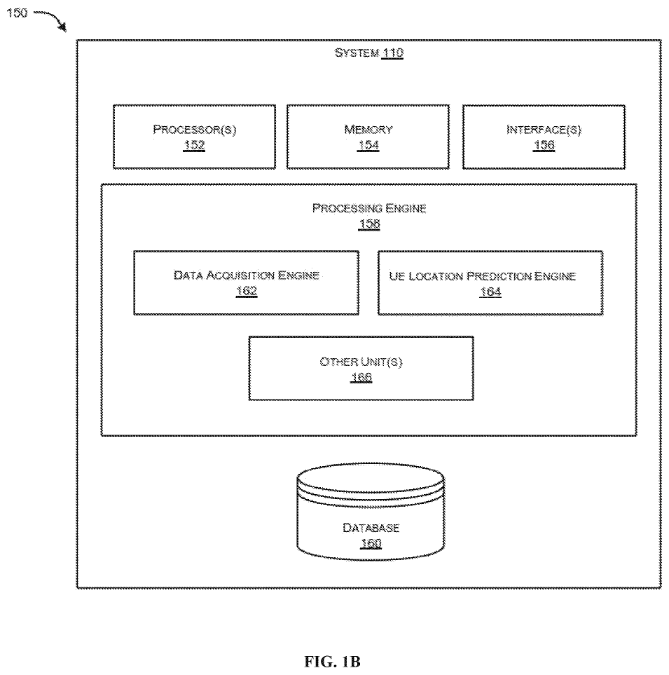

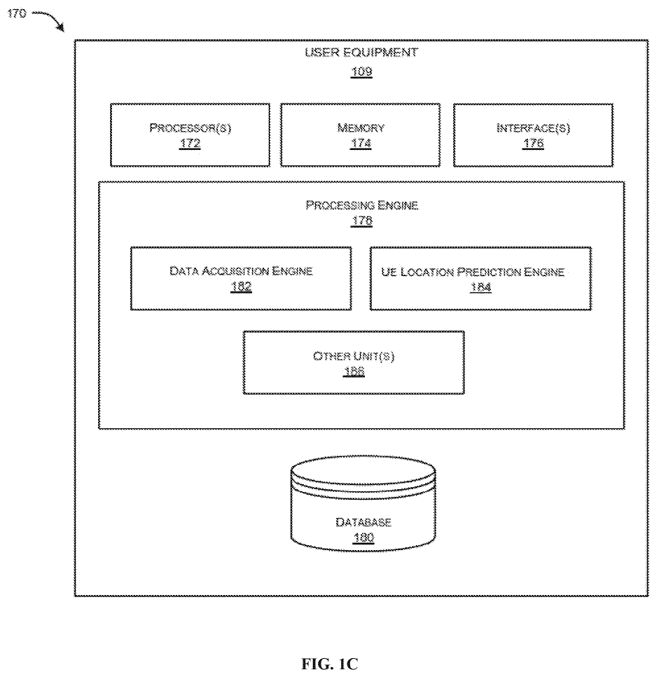

Referring to FIG. 1A that illustrates an exemplary network architecture for a wireless network (100) (also referred to as network architecture (100)) in which or with which the system (110) of the present disclosure can be implemented, in accordance with an embodiment of the present disclosure. As illustrated, the exemplary network architecture (100) may be equipped with a system (110) that may be communicatively coupled to a plurality of first computing devices (104-1, 104-2, 104-3 . . . 104-N) (interchangeably referred to as user equipment (104-1, 104-2, 104-3 . . . 104-N) and (individually referred to as the user equipment (UE) (104) and collectively referred to as the UE (104)) through a second computing devices (102-1, 102-2, . . . 102-N) (interchangeably referred to as the base station (102-1, 102-2, . . . 102-N) and individually referred to as the base station (102) and collectively as base stations (102)) and the system (110) may be further operatively coupled to the base stations (102) via an Open radio access network Radio Unit (O-RU) (114). The system (110) may be further communicatively coupled to the one or more third computing devices (106) (interchangeably referred to as gNB distributed units (DU) or gNB DU 106), and one or more fourth computing devices (116) (interchangeably referred to as gNB control units (CU) or gNB CU 106). The one or more fourth computing devices (116) may be communicatively coupled to a plurality of fifth computing devices (118) (interchangeably referred to as Mobility Management Entity (MME)/Access and Mobility Function (AMF) (118) hereinafter). The one or more third computing devices (106) or gNB DU (106) may be satellites, GPS satellites or any non-terrestrial deployments but not limited to the like.

In an embodiment, the MME/AMF (118) may be operatively coupled to one or more processors (152) to perform prediction of accurate location of the UE (104).

In an embodiment, a sixth computing device (109) also referred to as a user equipment (UE) may be associated with the communication network (108) and the MME/AMF (118). The UE may be specialized with a plurality of modules and high end processor (172) to perform prediction of precise locations of the communicatively coupled UEs (104).

In an embodiment, the one or more processors (152) may be configured to receive a first set of data packets pertaining to queries associated with location of a UE and further receive a second set of data packets pertaining to a page request initiation response to the queries associated with the location of the UE. The system may be further configured to extract, from the UE, a first set of attributes pertaining to a serving cell ID of the UE and further extract, a second set of attributes pertaining to a static coarse location data of the UE based on the second set of data packets. In an embodiment, the static coarse location contains mobile country codes (MCC) and mobile network codes (MNC) and corresponding location coordinates associated with the location of the UE. In an embodiment, the system (110) may be associated with a coarse reference database as a fallback which can be used whenever there is a missing serving cell ID location information. In an exemplary embodiment, the coarse reference database can have static coarse location data comprising a combination of but not limited to MCC and MNC values of a serving cell UE and corresponding location coordinates. In an exemplary embodiment, the combination of but not limited to MCC and MNC values can be used as lookup to refer the coarse reference database. Based on the extracted first and second set of attributes, collect, a satellite reference data associated with a probable area in which the UE is available and identify from the satellite reference data, best visible satellites (106) serving the probable area in which the UE is available.

The system (110) may be then configured to derive the coarse location latitude and longitude value of the UE. Based on the coarse location derived, the satellite reference data can be derived and provided to the UE (104) as part of Advanced Global navigation satellite system (AGNSS) Assistance data. In an embodiment, the system (110) may be configured to extract a third set of attributes from the received the first set of attributes, the third set of attributes pertaining to requested QoS and serving cell identity (ID) in the E-UTRAN Cell Global Identifier (ECGI) format. The static coarse location stored in the coarse reference database may contain but not limited to ECGI value, latitude and longitude values of the UE. The system may further maintain the coarse reference database at par with ever increasing footprint for mobility networks.

The system may be configured to send the location request to an Enhanced Serving Mobile Location Centre (ESMLC). The ESMLC may be operatively coupled with the MME/AMF (118) and may contain the requested QoS and the serving cell id in the ECGI format as received from the UE.

In an embodiment, the satellite reference data may be obtained by the UE after sending a request for the satellite reference data to a predefined data base comprising the satellite reference data of a plurality of UEs serving the probable area. The system may consider the satellite reference data corresponding to the UE that provides a predetermined GNSS satellite signal for computing location.

In an exemplary embodiment, each serving combination of but not limited to MCC and MNC shall have respective location coordinates. The location coordinates can be latitude and longitude values of approximate centroid of the given combination of but not limited to MCC and MNC geography.

In an exemplary embodiment, a communication network (108) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

FIG. 1B illustrates an exemplary block diagram representation of proposed system (110) for predicting precise location of a UE, in accordance with an embodiment of the present disclosure. In an aspect, the system (110) may include one or more processor(s) (152). The one or more processor(s) (152) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (152) may be configured to fetch and execute computer-readable instructions stored in a memory (154) of the system (110). The memory (154) may be configured to store one or more computer-readable instructions or routines in a non-transitory computer readable storage medium, which may be fetched and executed to create or share data packets over a network service. The memory (154) may comprise any non-transitory storage device including, for example, volatile memory such as RAM, or non-volatile memory such as EPROM, flash memory, and the like.

In an embodiment, the system (110) may include an interface(s) 156. The interface(s) (156) may comprise a variety of interfaces, for example, interfaces for data input and output devices, referred to as I/O devices, storage devices, and the like. The interface(s) (156) may facilitate communication of the system (110). The interface(s) (156) may also provide a communication pathway for one or more components of the system (110). Examples of such components include, but are not limited to, processing unit/engine(s) (158) and a database (160).

The processing unit/engine(s) (158) may be implemented as a combination of hardware and programming (for example, programmable instructions) to implement one or more functionalities of the processing engine(s) (158). In examples described herein, such combinations of hardware and programming may be implemented in several different ways. For example, the programming for the processing engine(s) (158) may be processor executable instructions stored on a non-transitory machine-readable storage medium and the hardware for the processing engine(s) (158) may comprise a processing resource (for example, one or more processors), to execute such instructions. In the present examples, the machine-readable storage medium may store instructions that, when executed by the processing resource, implement the processing engine(s) (158). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (158) may be implemented by electronic circuitry.

The processing engine (158) may include one or more engines selected from any of a data acquisition engine (162), a location prediction engine (164), and other engines/units (166). The processing engine (158) may further edge based micro service event processing but not limited to the like and may be coupled with the MME/AMF (118). ESMLC, GMLC and the like.

FIG. 1C illustrates an exemplary representation of the user equipment (UE) (109), in accordance with an embodiment of the present disclosure. In an aspect, the UE (109) may comprise a processor (172). The processor (172) may be an edge based processor but not limited to it. The processor (172) may be implemented as one or more microprocessors, microcomputers, microcontrollers, digital signal processors, central processing units, logic circuitries, and/or any devices that process data based on operational instructions. Among other capabilities, the processor(s) (172) may be configured to fetch and execute computer-readable instructions stored in a memory (174) of the UE (109). The memory (174) may be configured to store one or more computer-readable instructions or routines in a non-transitory computer readable storage medium, which may be fetched and executed to create or share data packets over a network service. The memory (174) may comprise any non-transitory storage device including, for example, volatile memory such as RAM, or non-volatile memory such as EPROM, flash memory, and the like.

In an embodiment, the UE (109) may include an interface(s) 176. The interface(s) 206 may comprise a variety of interfaces, for example, interfaces for data input and output devices, referred to as I/O devices, storage devices, and the like. The interface(s) 206 may facilitate communication of the UE (109). Examples of such components include, but are not limited to, processing engine(s) 178 and a database (180).

The processing engine(s) (178) may be implemented as a combination of hardware and programming (for example, programmable instructions) to implement one or more functionalities of the processing engine(s) (178). In examples described herein, such combinations of hardware and programming may be implemented in several different ways. For example, the programming for the processing engine(s) (178) may be processor executable instructions stored on a non-transitory machine-readable storage medium and the hardware for the processing engine(s) (178) may comprise a processing resource (for example, one or more processors), to execute such instructions. In the present examples, the machine-readable storage medium may store instructions that, when executed by the processing resource, implement the processing engine(s) (178). In such examples, the UE (109) may comprise the machine-readable storage medium storing the instructions and the processing resource to execute the instructions, or the machine-readable storage medium may be separate but accessible to the UE (109) and the processing resource. In other examples, the processing engine(s) (178) may be implemented by electronic circuitry.

The processing engine (178) may include one or more engines selected from any of a data acquisition engine (182), a location prediction engine (184), and other engines/units (186). The processing engine (178) may further edge based micro service event processing but not limited to the like.

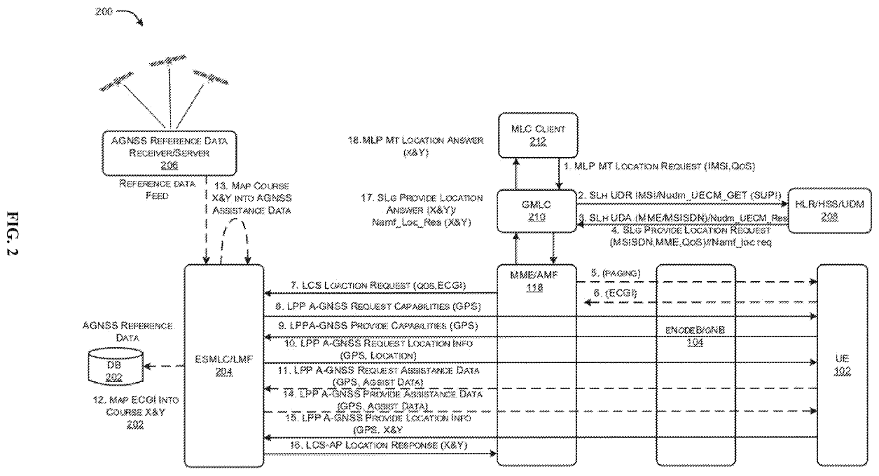

FIG. 2 illustrates an exemplary representation of a 3GPP defined AGNSS Location query call flow, in accordance with an embodiment of the present disclosure. As illustrated, the AGNSS based location query call flow diagram with relevant network elements is shown. As shown in the flow diagram, when a Gateway Mobile Location Centre (210) (GMLC (210)) queries an MME/AMF (118) for location with a set of details of an UE (102) and QoS, the MME/AMF (118) initiates a page request for the UE. In response, the UE (102) provides the serving cell ID information in ECGI format.

In an exemplary implementation, the MME/AMF (118) then sends location request to an Emergency Serving Mobile Location Center (ESMLC)/Location Management Function (LMF) (204) containing requested QoS and serving ECGI as received from the UE (102)). The ESMLC/LMF (204) handshakes LPP capability check with UE (102) and basis positive confirmation, requests for location based on AGNSS method to UE (102).

The UE (102) sends subsequent request asking for satellite reference data. Here the ESMLC/LMF (204) uses the ECGI value received cartier from the UE (102) via the MME/AMF (118) to derive the coarse latitude and longitude coordinates. To derive this coarse location, the ESMLC/LMF (204) needs to refer a database which contains ECGI and its latitude and longitude values.

Based on the coarse location, the ESMLC/LMF (204) identifies the reference data of best visible satellites serving the probable area in which UE (102) is available. The reference data is sent across to the UE (102) so that it can consider only those satellite reference GNSS signal for computing location, thereby reducing the time required to compute location as well as use the best available GNSS satellite signal. The computed location coordinates are then sent across to ESMLC/LMF (204) by UE (102) which is then sent to MME/AMF (118) as location response message. The MME/AMF (118) then forwards the computed location coordinates along with method details which was used to compute the location back to GMLC which then further responds back to the requesting location client.

In the existing method, one of the prerequisite for successful location computation is the availability of serving cell location details. For any reason, if this coarse reference information is not available with ESMLC/LMF (204), then the AGNSS based location method fails. Also maintaining this database itself is a challenge with ever increasing footprint for mobility networks. Additionally, with 5G, the number of serving cell sites is going to increase manifold. In such scenario, the probability of AGNSS based location failure due to absence of serving cell ID location data increases.

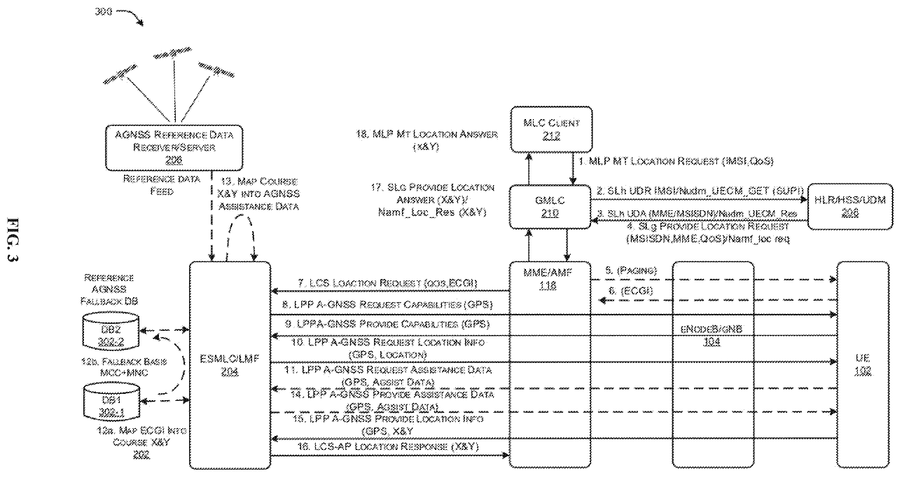

FIG. 3 illustrates an exemplary representation of AGNSS Location query call flow with the proposed system, in accordance with an embodiment of the present disclosure. As illustrated, in an aspect, a coarse reference database (302-2) can be added as a fallback which would be used whenever there is a missing serving cell ID location information. The proposed reference AGNSS fallback logic shall have static coarse location data which contains a combination of but not limited to MCC and MNC and corresponding location coordinates. For using the reference AGNSS fallback algorithm, ESMLC/LMF (204) will use the combination of but not limited to MCC and MNC which is available as part of ECGI of the serving cell ID. The combination of but not limited to MCC and MNC shall be used as lookup to refer the AGNSS Reference fallback database and derive the coarse location latitude and longitude value. Based on this coarse location, the satellite reference data shall be derived and provided to UE (102) as part of AGNSS Assistance data.

Additionally, each serving combination of but not limited to MCC and MNC shall have respective location coordinates. These location coordinates shall be typically the latitude and longitude values of approximate centroid of the given combination of but not limited to MCC and MNC geography.

TABLE 1
highlights AGNSS Reference Fallback table structure

| Sr. | | | | Ref | Ref |
|---|---|---|---|---|---|
| No. | Circle | MCC | MNC | Latitude | Longitude |
| 1 | Mumbai | 405 | 874 | 19.118209 | 72.890789 |
| 2 | Gujarat | 405 | 857 | 22.730386 | 71.653090 |
| 3 | Maharashtra | 405 | 864 | 19.736518 | 76.649130 |
| 4 | Madhya Pradesh | 405 | 863 | 23.796957 | 78.485451 |
| 5 | Andhra Pradesh | 405 | 854 | 16.460251 | 79.910947 |
| 6 | Karnataka | 405 | 861 | 14.548145 | 75.928469 |
| 7 | Kerala | 405 | 862 | 10.716294 | 76.366178 |
| 8 | Tamil Nadu | 405 | 869 | 11.241949 | 78.502257 |
| 9 | Delhi | 405 | 872 | 28.668670 | 77.146087 |
| 10 | Haryana | 405 | 858 | 29.273764 | 76.407875 |
| 11 | Himachal Pradesh | 405 | 859 | 31.922596 | 77.481409 |
| 12 | Jammu & Kashmir | 405 | 860 | 33.613586 | 75.942975 |
| 13 | Punjab | 405 | 867 | 30.800900 | 75.595835 |
| 14 | Rajasthan | 405 | 868 | 26.557598 | 73.947583 |
| 15 | UTTAR PRADESH | 405 | 871 | 27.010917 | 82.319520 |
| | (EAST) | | | | |
| 16 | UTTAR PRADESH | 405 | 870 | 27.138093 | 79.682801 |
| | (WEST) | | | | |
| 17 | Assam | 405 | 855 | 26.341630 | 92.836953 |
| 18 | Bihar | 405 | 856 | 25.837098 | 86.018693 |
| 19 | Kolkata | 405 | 873 | 22.589560 | 88.413450 |
| 20 | North East | 405 | 865 | 25.838513 | 93.427269 |
| 21 | Orissa | 405 | 866 | 20.609044 | 84.531204 |
| 22 | West Bengal | 405 | 840 | 23.673897 | 87.814129 |

In an exemplary embodiment, whenever the coarse reference (302-2) is referred as fallback reference database for AGNSS based location queries, the coarse location deviation shall be high as compared to serving cell ID based coarse location but will continue to provide AGNSS assistance data of satellites which are in the probable area of the UE. The coarse location deviation range shall be governed by the geography covered by the given combination of but not limited to MCC and MNC region.

In an exemplary embodiment, the system can be applicable for but not limited to location query in 5G network with equivalent 5G specific nodes and call flow.

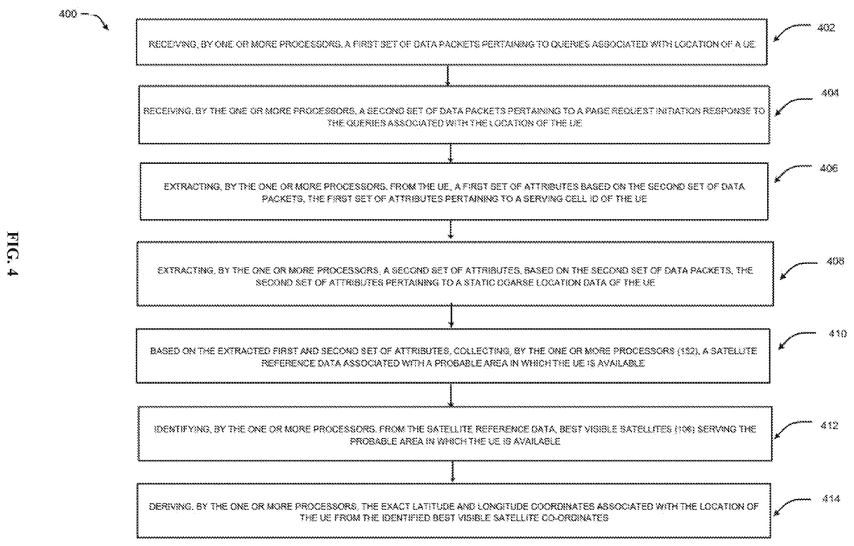

FIG. 4 illustrates an exemplary flow diagram of a method (400) in which or with which embodiments of the present invention can be utilized, in accordance with embodiments of the present disclosure. As illustrated, the method (400) defines the steps for predicting precise location of a user equipment (UE) in a communication network.

In an aspect, the method (400) may include at 402, the step of receiving, by one or more processors (152), a first set of data packets pertaining to queries associated with location of a UE (104).

The method (400) may also include at 404, the step of receiving, by the one or more processors (152), a second set of data packets pertaining to a page request initiation response to the queries associated with the location of the UE.

The method (400) may further include at 406, the step of extracting, by the one or more processors (152), from the UE (104), a first set of attributes based on the second set of data packets, the first set of attributes pertaining to a serving cell ID of the UE.

Further the method (400) may include at 408, the step of extracting, by the one or more processors (152), a second set of attributes, based on the second set of data packets, the second set of attributes pertaining to a static coarse location data of the UE, and wherein the static coarse location contains mobile country codes (MCC) and mobile network codes (MNC) and corresponding location coordinates associated with the location of the UE.

Based on the extracted first and second set of attributes, the method (400) may include at 410, the step of collecting, by the one or more processors (152), a satellite reference data associated with a probable area in which the UE is available.

The method may then include at 412, the step of identifying, by the one or more processors (152), from the satellite reference data, best visible satellites (106) serving the probable area in which the UE is available.

Furthermore, the method may include at 414, the step of deriving, by the one or more processors (152), the exact latitude and longitude coordinates associated with the location of the UE from the identified best visible satellite (106) co-ordinates.

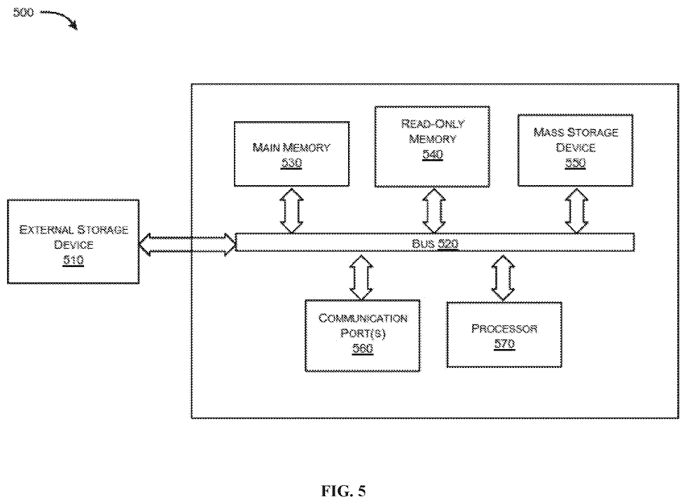

As shown in FIG. 5, computer system (500) can include an external storage device (510), a bus (520), a main memory (530), a read only memory (540), a mass storage device (550), communication port (560), and a processor (570). A person skilled in the art will appreciate that the computer system may include more than one processor and communication ports. Processor (570) may include various modules associated with embodiments of the present invention. Communication port (550) can be any of an RS-232 port for use with a modem-based dialup connection, a 10/100 Ethernet port, a Gigabit or 10 Gigabit port using copper or fibre, a serial port, a parallel port, or other existing or future ports. Communication port (560) may be chosen depending on a network, or any network to which computer system connects. Memory (530) can be Random Access Memory (RAM), or any other dynamic storage device commonly known in the art. Read-only memory (540) can be any static storage device(s). Mass storage (550) may be any current or future mass storage solution, which can be used to store information and/or instructions.

Bus (520) communicatively couples' processor(s) (570) with the other memory, storage and communication blocks. Optionally, operator and administrative interfaces. e.g., a display, keyboard, and a cursor control device, may also be coupled to bus (520) to support direct operator interaction with a computer system. Other operator and administrative interfaces can be provided through network connections connected through communication port (560). Components described above are meant only to exemplify various possibilities. In no way should the aforementioned exemplary computer system limit the scope of the present disclosure.

Thus, the present disclosure provides for a unique and efficient system that facilitates increase in the success rate of AGNSS based location method as well as provides can derive the reference coarse location of the UE which is further used to send assistance data to the UE. Based on the assistance data only, the UE is able to compute a precise AGNSS based location effectively as well as ensuring minimal response time. The system further provides an option to get away with dependency on cell ID database required for computing successful AGNSS based location method. The solution addresses the issue of AGNSS based location failure due to lack of reference location details. As a result, location services accuracy gets enhanced due to greater success of AGNSS based location. The system and method further can eliminate the dependency on network specific coarse location reference database. With enhanced AGNSS success rate achieved by this solution, the fallback to lower accurate methods gets eliminated, thereby enhancing turnaround time of location services platform. The proposed AGNSS Reference fallback can be considered as an enhancement to Location services 3GPP standards and improves AGNSS success rate. The system and method provides for a Simplified approach for providing statie coarse reference coordinates rather than relying on dynamic serving cell ID DB and can be a USP for any Location services Platform. Further, there can be high possibility of adoption by standards organization for 40 as well as 5G specifications.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark. IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### ADVANTAGES OF THE PRESENT DISCLOSURE

The present disclosure provides for a system that addresses dependency of AGNSS based location query success on Service Cell ID location information.

The present disclosure provides for a system that improves AGNSS based location query method success rate.

The present disclosure provides for a system that enhances possibility of high accurate location output from location services platform.

The present disclosure provides for a system that improves response time of location query by minimizing.

We claim:

1. A system (110) for predicting precise location of a user equipment (UE) in a communication network (108), said system (110) comprising:
one or more processors (152), said one or more processors (152) operatively coupled to one or more UE (104) associated with one or more users, wherein the one or UE (104) are communicatively coupled to one or network elements (cells) of the communication network (108), wherein the one or more processors (152) executes a set of executable instructions that are stored in a memory (154), upon execution of which, the one or more processors (152) causes the system (110) to:
receive a first set of data packets, said first set of data packets pertaining to queries associated with location of a UE;
receive a second set of data packets pertaining to a page request initiation response to the queries associated with the location of the UE;
extract, from the UE, a first set of attributes based on the second set of data packets, the first set of attributes pertaining to a serving cell ID of the UE;
extract, a second set of attributes, based on the second set of data packets, the second set of attributes pertaining to a static coarse location data of the UE, and wherein the static coarse location contains mobile country codes (MCC) and mobile network codes (MNC) and corresponding location coordinates associated with the location of the UE;
based on the extracted first and second set of attributes, collect, a satellite reference data associated with a probable area in which the UE is available;
identify from the satellite reference data, best visible satellites (106) serving the probable area in which the UE is available; and,
derive the exact latitude and longitude coordinates associated with the location of the UE from the identified best visible satellite (106) co-ordinates.

2. The system (110) as claimed in claim 1, wherein the system (110) is configured to extract a third set of attributes from the received the first set of attributes, the third set of attributes pertaining to a requested Quality of Service (QOS) and serving cell identity (ID) in an E-UTRAN Cell Global Identifier (ECGI) format.

3. The system (110) as claimed in claim 1, wherein the system (110) is configured to receive the third set of attributes from the UE (104).

4. The system (110) as claimed in claim 1, wherein the system (110) is configured to send the location request to an Enhanced Serving Mobile Location Centre (ESMLC), wherein the ESMLC contains the requested QoS and the serving cell id in the ECGI format as received from the UE.

5. The system (110) as claimed in claim 1, wherein the satellite reference data is obtained by the UE after sending a request for the satellite reference data to a predefined data base comprising the satellite reference data of a plurality of UEs serving the probable area.

6. The system (110) as claimed in claim 1, wherein the system (110) is configured to consider the satellite reference data corresponding to the UE that provides a predetermined GNSS satellite signal for computing location.

7. The system (110) as claimed in claim 1, wherein the system (110) is further configured to store the static coarse location in the coarse reference database which contains ECGI value, latitude and longitude values of the UE.

8. The system (110) as claimed in claim 1, wherein the system (110) is configured to create the coarse reference database as a fallback which is used whenever there is a missing serving cell ID location information.

9. The system (110) as claimed in claim 1, wherein the system (110) is configured to maintain the coarse reference database at par with ever increasing footprint for mobility networks.

10. The system (110) as claimed in claim 1, wherein the system (110) is configured to determine respective location coordinates of the UE based on the serving MCC and MNC values, wherein the location coordinates is the latitude and longitude values of approximate centroid of the said MCC and MNC geography.

11. A user equipment (UE) (109) for predicting precise location of a second user equipment (UE) in a communication network (106), said UE comprising:
a processor (172) operatively coupled to one or more second UE (104), wherein the one or second UE (104) are communicatively coupled to one or network elements (cells) of the communication network (108), wherein the processor (172) executes a set of executable instructions that are stored in a memory (174), upon execution of which, the processor (172) causes the UE (109) to:
receive a first set of data packets, said first set of data packets pertaining to queries associated with location of a seconds UE;
receive a second set of data packets pertaining to a page request initiation response to the queries associated with the location of the second UE;
extract, from the UE, a first set of attributes based on the second set of data packets, the first set of attributes pertaining to a serving cell ID of the second UE;
extract, a second set of attributes, based on the second set of data packets, the second set of attributes pertaining to a static coarse location data of the UE, and wherein the static coarse location contains mobile country codes (MCC) and mobile network codes (MNC) and corresponding location coordinates associated with the location of the UE;
based on the extracted first and second set of attributes, collect, a satellite reference data associated with a probable area in which the second UE is available
identify from the satellite reference data, best visible satellites (106) serving the probable area in which the second UE is available; and,
derive the exact latitude and longitude coordinates associated with the location of the second UE from the identified best visible satellite (106) co-ordinates.

12. A method (400) for predicting precise location of a user equipment (UE) in a communication network (106), said method comprising:
receiving, by one or more processors (152), a first set of data packets, said first set of data packets pertaining to queries associated with location of a UE,
wherein said one or more processors (152) are operatively coupled to one or more UE (104) associated with one or more users (102), wherein the one or UE (104) are communicatively coupled to one or network elements (cells) of the communication network (108), and wherein the one or more processors (152) executes a set of executable instructions that are stored in a memory (154);
receiving, by the one or more processors (152), a second set of data packets pertaining to a page request initiation response to the queries associated with the location of the UE;
extracting, by the one or more processors (152), from the UE, a first set of attributes based on the second set of data packets, the first set of attributes pertaining to a serving cell ID of the UE;
extracting, by the one or more processors (152), a second set of attributes, based on the second set of data packets, the second set of attributes pertaining to a static coarse location data of the UE, and wherein the static coarse location contains mobile country codes (MCC) and mobile network codes (MNC) and corresponding location coordinates associated with the location of the UE;
based on the extracted first and second set of attributes, collecting, by the one or more processors (152), a satellite reference data associated with a probable area in which the UE is available;
identifying, by the one or more processors (152), from the satellite reference data, best visible satellites (106) serving the probable area in which the UE is available; and,
deriving, by the one or more processors (152), the exact latitude and longitude coordinates associated with the location of the UE from the identified best visible satellite co-ordinates.

13. The method (400) as claimed in claim 12, wherein the method further comprises the step of extracting, by the one or more processors (152), a third set of attributes from the received the first set of attributes, the third set of attributes pertaining to requested QoS and serving cell identity (ID) in an E-UTRAN Cell Global Identifier (ECGI) format.

14. The method (400) as claimed in claim 12, wherein the method further comprises the step of receiving, by the one or more processors (152), the third set of attributes from the UE.

15. The method (400) as claimed in claim 12, wherein the method further comprises the step of sending, by the one or more processors (152), the location request to an Enhanced Serving Mobile Location Centre (ESMLC), wherein the ESMLC contains the requested QoS and the serving cell id in ECGI format as received from the UE.

16. The method (400) as claimed in claim 12, wherein the satellite reference data is obtained by the UE after sending a request for the satellite reference data to a predefined data base comprising the satellite reference data of a plurality of UEs serving the probable area.

17. The method (400) as claimed in claim 12, wherein the method (400) further comprises the step of considering, by the one or more processors (152), the satellite reference data corresponding to the UE that provides a predetermined GNSS satellite signal for computing location.

18. The method (400) as claimed in claim 12, wherein the method (400) further comprises the step of storing the static coarse location in a coarse reference database which contains ECGI value, latitude and longitude values of the UE.

19. The method (400) as claimed in claim 18, wherein the method (400) further comprises the step of creating, by the one or more processors (152), the coarse reference database as a fallback which is used whenever there is a missing serving cell ID location information.

20. The method (400) as claimed in claim 19, wherein the method (400) further comprises the step of maintaining, by the one or more processors (152), the coarse reference database at par with increasing footprint for mobility networks.

21. The method (400) as claimed in claim 12, wherein the method (400) further comprises the step of determining, by the one or more processors (152), respective location coordinates of the UE based on the serving MCC and MNC values, wherein the location coordinates is the latitude and longitude values of approximate centroid of the said MCC and MNC geography.
